(19) United States
(12) Patent Application Publication
(10) Pub. No.: US 2025/0103404 A1
(43) Pub. Date: Mar. 27, 2025

(54) Log Storage System with Improved Utilization of Storage Space

(71) Applicant: International Business Machines Corporation, Armonk, NY (US)

(72) Inventors: Xizhuo Zhang, Beijing (CN); Hui Wang, Beijing (CN); Zhao Yu Wang, Beijing (CN); Jing Ren, Beijing (CN); Jing Wen Chen, Beijing (CN); Yi Jie Ma, Beijing (CN)

(21) Appl. No.: 18/475,510

(22) Filed: Sep. 27, 2023

(51) Int. Cl. G06F 9/54

(52) U.S. Cl. CPC G06F 9/546

(57) ABSTRACT

An approach for managing log messages. In this approach, a hierarchical structure identifies primary and secondary relationships between the log messages. In this approach, primary log messages in the log messages that has one or more secondary log messages is identified using the hierarchical structure. One or more pointers are added to each primary log message in the log messages having the one or more secondary log messages. Each pointer points to a secondary log message in the hierarchical structure. The one or more secondary log messages are removed from the log messages to form remaining log messages. Header information from log message headers and content information from log message content in the remaining log messages are saved to form compressed log information.

### BACKGROUND

The disclosure relates generally to an improved computer system and more specifically to processing and managing the storage of logs in a computer system.

In a computing environment, logs are records or files that are generated to capture information in the computing environment. These logs can capture events that occur within the computing environment. These events can occur in software, hardware, computers, devices, or in other locations in the computing environment. An event can be a transaction, an operation, or some other activity or change. For example, an event can be a resource allocation, a system error, an application error, an access violation, a firewall breach, or an establishment of a network connection.

These logs can provide insight into the operation of network devices, applications, services, and users. The information in logs can be used in performing various tasks in software engineering or network management. For example, logs can be used to identify and resolve bugs or errors. Further, logs can be used to increase the performance within the computing environment as well as increased security.

### SUMMARY

According to one illustrative embodiment, one or more of a computer implemented method, a computer system, and a computer program product manage log messages. One or more computer processors create a hierarchical structure identifying primary and secondary relationships between the log messages. The one or more computer processors identify each primary log message in the log messages that has one or more secondary log messages using the hierarchical structure. The one or more computer processors add one or more pointers to each primary log message in the log messages having the one or more secondary log messages. Each pointer points to a secondary log message in the hierarchical structure. The one or more computer processors remove the one or more secondary log messages from the log messages to form remaining log messages. The one or more computer processors save header information from log message headers and content information from log message content in the remaining log messages to form compressed log information.

### BRIEF DESCRIPTION OF THE DRAWINGS

FIG. 1 is a block diagram of a computing environment in which illustrative embodiments can be implemented;

FIG. 2 is a block diagram of a log environment in accordance with an illustrative embodiment;

FIG. 3 is an illustration of log model creation in accordance with an illustrative embodiment;

FIG. 4 is a data flow diagram illustrating compressing logs in accordance with an illustrative embodiment;

FIG. 5 is a tree in accordance with an illustrative embodiment;

FIG. 6 is a flowchart of a process for creating log message objects in accordance with an illustrative embodiment;

FIGS. 7A and 7B are a flowchart of a process for creating a tree for log messages in a log using a log model in accordance with an illustrative embodiment;

FIG. 8 is a flowchart of a process for managing log messages in accordance with an illustrative embodiment;

FIG. 9 is a flowchart of a process for creating a hierarchical structure in accordance with an illustrative embodiment;

FIG. 10 is a flowchart of a process for saving header information and content information in accordance with an illustrative embodiment;

FIG. 11 is a flowchart of a process for creating a log model in accordance with an illustrative embodiment;

FIG. 12 is a flowchart of a process for creating a log model in accordance with an illustrative embodiment; and

FIG. 13 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

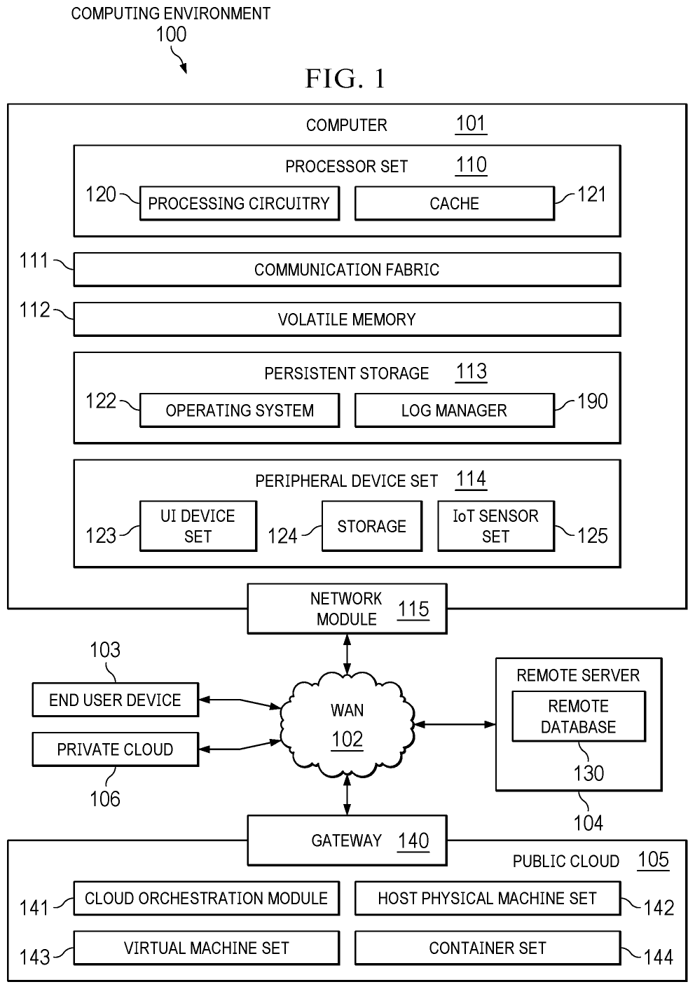

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as log manager 190. Log manager 190 operates manage longs in a manner that reduces storage space, reduces computing resource usage, or both. In addition to log manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and log manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in log manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in log manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative examples recognize and take into account a number of different considerations as described herein. For example, logs often require long storage times to be useful in analyzing recurrent problems or identifying security issues. Saving the logs in storage consumes a large amount of storage space and computing resources. Existing log processing systems do not manage logs in a manner that reduces the amount of space needed to store or process logs.

Logs often have various combinations or patterns that can occur repeatedly. These combinations or patterns of logs can be identified relationships between the logs used to save storage space. The patterns of logs can be used to compress the log information. Further, knowing these patterns can increase the ability to recover information from the logs when retrieving compressed information for the logs from storage.

Thus, the illustrative embodiments provide a computer implemented method, apparatus, system, and computer program product for managing logs. In one illustrative example, one or more computer processors create a hierarchical structure identifying primary and secondary relationships between the log messages. The one or more computer processors identify each primary log message in the log messages that has one or more secondary log messages using the hierarchical structure. The one or more computer processors add one or more pointers to each primary log message in the log messages having the one or more secondary log messages, wherein each pointer points to a secondary log message in the hierarchical structure. The one or more computer processors remove the one or more secondary log messages from the log messages to form remaining log messages. The one or more computer processors save header information from log message headers and content information from log message content in the remaining log messages to form compressed log information.

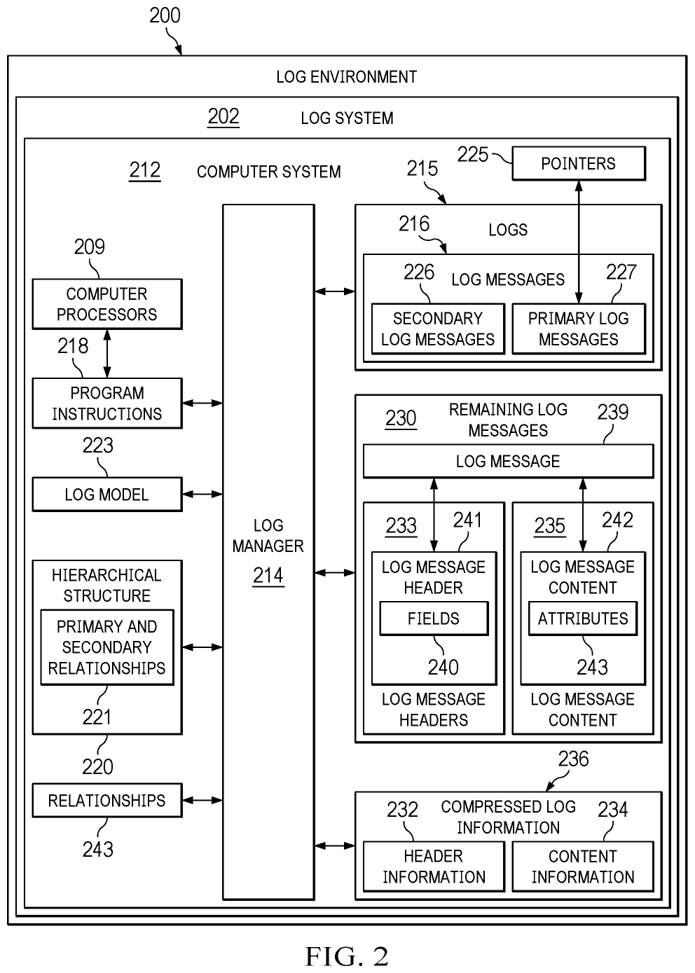

With reference now to FIG. 2, a block diagram of a log environment is depicted in accordance with an illustrative embodiment. In this illustrative example, log environment 200 includes components that can be implemented in hardware such as the hardware shown in computing environment 100 in FIG. 1.

In this example, log system 202 can manage logs 215. In particular, log system 202 can manage the processing and storage of log messages 216 in one or more of logs 215. As depicted, log system 202 comprises computer system 212 and log manager 214. Log manager 214 is located in computer system 212. Log manager 214 can be implemented using log manager 190 in FIG. 1.

Example, log manager 214 can be implemented in software, hardware, firmware or a combination thereof. When software is used, the operations performed by log manager 214 can be implemented in program instructions configured to run on hardware, such as a computer processor. When firmware is used, the operations performed by log manager 214 can be implemented in program instructions and data and stored in persistent memory to run on a computer processor. When hardware is employed, the hardware can include circuits that operate to perform the operations in log manager 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of computer processors 209 that are capable of executing program instructions 218 implementing processes in the illustrative examples. In other words, program instructions 218 are computer readable program instructions.

As used herein, a computer processor in the number of computer processors 209 is a hardware device and is comprised of hardware circuits such as those on an integrated circuit that respond to and process instructions and program code that operate a computer. A computer processor can be implemented using processor set 110 in FIG. 1. When the number of computer processors 209 executes program instructions 218 for a process, the number of computer processors 209 can be one or more computer processors that are in the same computer or in different computers. In other words, the process can be distributed between computer processors 209 on the same or different computers in computer system 212.

Further, the number of computer processors 209 can be of the same type or different types of computer processors. For example, the number of computer processors 209 can be selected from at least one of a single core processor, a dual-core processor, a multi-processor core, a general-purpose central processing unit (CPU), a graphics processing unit (GPU), a digital signal processor (DSP), or some other type of computer processor.

In this example, log manager 214 creates hierarchical structure 220 that identifies relationships 219 between log messages 216. In these examples, the relationships 221 are primary and secondary relationships 221 between log messages 216. In one example, hierarchical structure 220 indicates when a primary log message is followed by a secondary log message. In the depicted example, primary and secondary relationships 221 can also indicate that a primary log message is followed by multiple secondary log messages. For example, a primary log message can be followed by two secondary log messages. In other words, a secondary log message to a primary log message can have one or more other secondary log messages that follows the secondary log message in a chain or path in a hierarchical structure such as a tree.

Hierarchical structure 220 can take a number of different forms. For example, hierarchical structure 220 can be selected from a group comprising a tree structure, a directed acyclic graph, a database, a multilevel list, and other types of structures that can be used to identify relationships between log messages 216. In one example, this hierarchical structure can be created using log model 223 identifying primary and secondary relationships 221 between log messages 216.

Log manager 214 identifies each log message in log messages 216 that has one or more secondary log messages using the hierarchical structure 220. Log manager 214 add one or more pointers 225 to each log message in log messages 216 having the one or more secondary log messages 226. These log messages with one or more secondary log messages are referred to as primary log messages 227. In this example, each pointer in pointers 225 points to a secondary log message in hierarchical structure 220. In this manner, log manager 214 can associate a primary log message with a secondary log message by adding information such as a pointer. This pointer can be a special symbol that identifies the secondary log message that is associated with the primary log message.

Log manager 214 removes secondary log messages 226 from the log messages 216 to form remaining log messages 230. In other words, multiple instances of a secondary log message can be removed from log messages 216. For example, if log messages 216 includes seven instances of a secondary log message, the seven instances of the secondary log message can be removed from log messages 216. The location of the log message in hierarchical structure 220 can be added to each of the seven primary log messages having the secondary log message.

In this example, the secondary log messages are stored in hierarchical structure 220. Only one instance of a secondary log message for a particular event is stored. As a result, the size of log messages 216 can be reduced through removing duplicate log messages.

Log manager 214 saves header information 232 from log message headers 233 and content information 234 from log message content 235 in remaining log messages 230 to form compressed log information 236. In this example, these remaining log messages are primary log messages. In these examples, header information 232 and content information 234 are simplified or converted to form compressed log information 236 in a manner that takes less space for storage.

In this illustrative example, log manager 214 can save log information by splitting log message 239 in remaining log messages 230 into log message header 241 and log message content 242. Log manager 214 identifies fields 240 in the log message header 241 to form header information 232. Log manager 214 identifies attributes 243 in log message content 242 to form content information 234.

Fields 240 can take a number of different forms. For example, fields 240 can be selected from at least one of a system name, a timestamp, a job identifier, a user exit flag, a domain, or other suitable type of field. Attributes 243 can also take a number of different forms. In this example, attributes 243 can be selected from at least one of an event mapping object, a parameters mapping object, an event identifier, a parameter identifier, a secondary log message identifier, or other attributes. With this information obtained from log message 239, log manager 214 saves fields 240 and attributes 243 in compressed log information 236. This process can be performed with other log messages in remaining log messages 230 to form compressed log information 236.

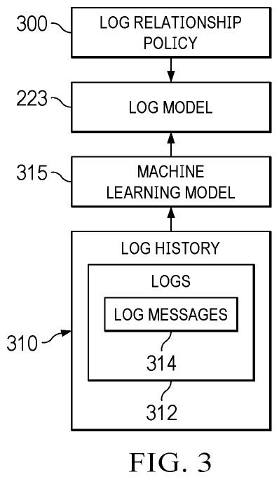

Turning next to FIG. 3, an illustration of log model creation is depicted in accordance with an illustrative embodiment. In the illustrative examples, the same reference numeral may be used in more than one figure. This reuse of a reference numeral in different figures represents the same element in the different figures.

In this illustrative example, log model 223 can be created in a number of different ways. For example, log relationship policy 300 can be used to create log model 223. Log relationship policy 300 can be a set of rules or guidelines that define relationships between log messages. In this example, these relationships are structural relationships identifying when a log message has other log messages that necessarily follow the log message. For example, log relationship policy 300 can identify when the occurrence of one log message is followed by one or more other log messages. In one illustrative example, log relationship policy 300 can take the form of the knowledge center. A knowledge center is a document that identifies structural relationships between log messages.

With log relationship policy 300, rules can be identified in log relationship policy 300 that identify what log messages will have other log messages when present in a log. These rules can be defined as a list, dictionary, or other data structure. Logic can be created to process log messages based on the rules. The logic can also include adding nodes to a tree based on the presence of log messages and the rules. This logic can be implemented in software to form log model 223.

If log relationship policy 300 is unavailable, log model 223 can be generated from historical data. For example, log history 310 can contain logs 312 with log messages 314. The sequence of log messages 314 can be used to train machine learning model 315. In the train form, machine learning model 315 is log model 223. In this illustrative example, machine learning model 315 can take a number different forms. For example, machine learning model 315 can be a recurrent neural network (RNN), long short-term memory (LSTM), a convolutional neural network (CNN), a transformer model, or other suitable types of machine learning models that can be trained to predict relationships between log messages.

In this illustrative example, machine learning model 315 can incorporate or use a tree decoding mechanism to produce a tree as an output. This technique can be used with recursive neural networks that are designed to produce treelike outputs. In other examples, the architecture of machine learning model can be modified to output treaties. For example, a LSTM or transformer model can be modified to output a tree. Techniques such as a beam search with a tree constraint can be used with these models.

In one illustrative example, one or more technical solutions are present that overcome a problem with managing log messages in a manner that efficiently uses resources. In the illustrative examples, issues such as storage space and processing resources can occur with large numbers of log messages. As a result, one or more illustrative examples enable compressing log messages to provide greater compression as compared to current techniques for reducing storage space. Further, the different illustrative examples can reduce processing resources needed to process log messages. For example, the log messages can be saved in a format that can be used to restore or locate information using less processing resources as current techniques.

Computer system 212 can be configured to perform at least one of the steps, operations, or actions described in the different illustrative examples using software, hardware, firmware or a combination thereof. As a result, computer system 212 operates as a special purpose computer system in which log manager 214 in computer system 212 enables managing log messages more efficiently as compared to current techniques. In particular, log manager 214 transforms computer system 212 into a special purpose computer system as compared to currently available general computer systems that do not have log manager 214.

In the illustrative example, the use of log manager 214 in computer system 212 integrates processes into a practical application for method managing log messages that increases the performance of computer system 212. In other words, log manager 214 in computer system 212 is directed to a practical application of processes integrated into log manager 214 in computer system 212 that can reduce duplicate secondary log messages through adding pointers to the primary messages having secondary messages. For example, 35 log messages are each followed by the same secondary message. As a result, 34 duplicate secondary messages can be removed. The remaining secondary message can be stored in a data structure such as a tree. Thus, as the number of duplications of secondary messages occur because of primary and secondary relationships, the amount of space savings further increases using one or more illustrative examples.

Thus, the illustrative examples can reduce issues with logs that use large amounts of storage. In one or more illustrative examples, the log is compressed or simplified. The structure of the log is changed based on a log model that has logic implementing rules on the relationship between log messages. This log model can reduce redundant information in the log file to reduce storage usage. The log messages in the log can be simplified based on the rules in the log model. Further, a tree or other hierarchical structure is created to identify the relationships between log messages in the log.

The illustration of log environment 200 and the different components in FIGS. 2 and 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

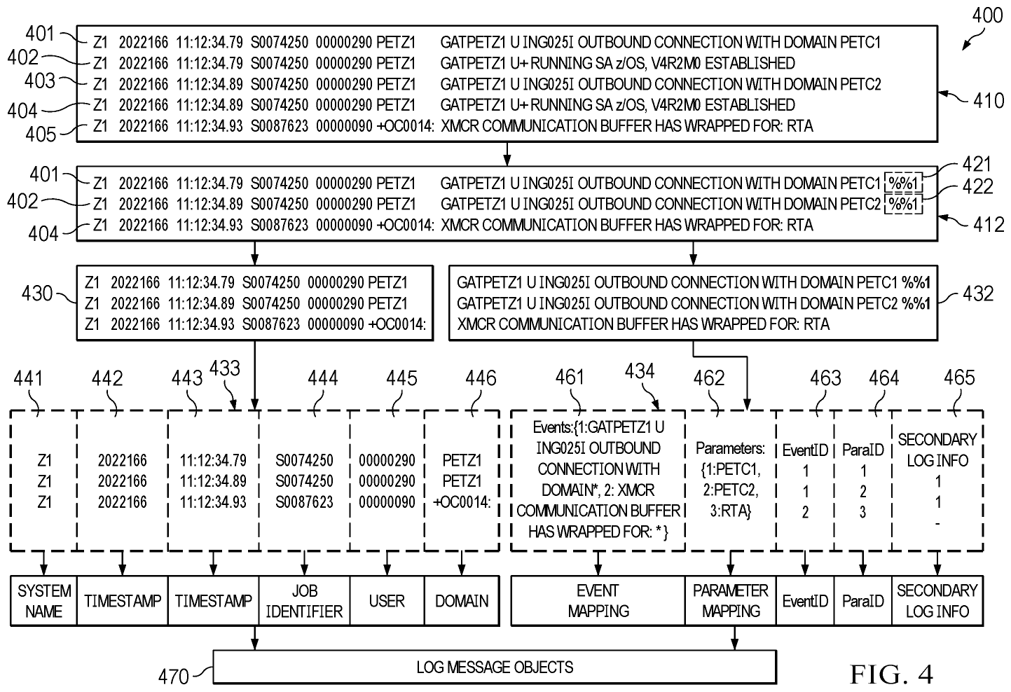

Turning next to FIG. 4, a data flow diagram illustrating a compressing log is depicted in accordance with an illustrative embodiment. In this illustrative example, data flow 400 is an example of data flow that can be performed by log manager 214 to process logs.

In this example, log 410 is comprised of 5 log messages, log message 401, log message 402, log message 403, log message 404, and log message 405. In this example, log message 401 and log message 403 are for the same event with different attributes.

Log message 402 and log message 404 are identical log messages. In this example, the log messages always follow the event for log message 401 and log message 403. In this illustrative example, the log message 402 is a secondary log message to log message 401. Log message 404 is a secondary log message to log message 403.

In this example, these log messages in log 410 are processed to remove the secondary log messages as shown by the remaining log messages in processed log 412. The presence of the secondary log messages identified using pointers. These pointers are added to each of the log messages to identify the secondary log messages.

As depicted, log message 401 has pointer 421 and log message 402 has pointer 422. In this example, these pointers take the form of special symbols. Pointer 421 is “% %1” in which “% %” indicates the presence of a secondary log message in a tree structure and “1” identifies the location of the secondary log message in the tree. In similar fashion, pointer 422 is “% %2” in which “% %” indicates the presence of a secondary message and “2” identifies the position of the secondary message in the tree.

As can be seen, log 410 has been compressed from five messages to three messages. As the number of log messages analog increase, then reduction in size can reduce storage needed to save the log.

In this example, the log messages in processed log 412 are split into log message header 430 and log message content 432. In this example, fields 433 are identified in log message header 430 and attributes are identified in log message content 432.

As depicted, fields 433 include system name 441, timestamp 442, timestamp 443, job identifier 444, user 445, and domain 446. In this example, system name 441 is a machine or virtual machine on which the log 410 was generated. Timestamp 442 is a date of the log and timestamp 443 is a time of the log. Job identifier 444 identifies the job, user 445 identifies application or other user, and domain 446 identifies the domain in which the log was generated.

In this example, attributes 434 comprises event mapping 461, parameter mapping 462, event identifier 463, parameter identifier 464, and secondary log info 466. Event mapping 461 contains the text for the events in log message content 432 of the log messages from processed log 412. Parameter mapping 462 identifies parameters associated with the events in log messages content 432 for log messages from processed log 412. Event identifier 463 identifies the event for a log message. Parameter identifier 464 identifies a parameter in parameters 624 for a log message. Secondary log info 465 identifies the location of secondary log message. In this example, the value identifies the location of the secondary log message in a hierarchical structure such as a tree. For example, secondary log info 465 can take the form of known identifiers for nodes in the tree. The primary log message subsequent to one or more secondary log messages can be traced through a single path in the tree.

In this example, this information is stored as log message objects 470. In this example, each log message object in log message objects 470 contains fields 433 and attributes 434 for a log message in processed log 412. In other words, a one-to-one correspondence is present between log messages and the message log. In this depicted example, log message objects 470 comprises three message log objects for the log messages.

The illustration of data flow 400 is provided as an example of an implementation of dataflow for processing log messages and are not meant to limit the manner in which other illustrative examples can be implemented. For example, only five log messages are shown in FIG. 4 to illustrate steps in data flow 400 used to compress or simplify a log. This number of log messages illustrate the different steps in data flow 400. Other logs can contain other numbers of messages such as 45 log messages, 200 log messages, 1000 or some other number of log messages.

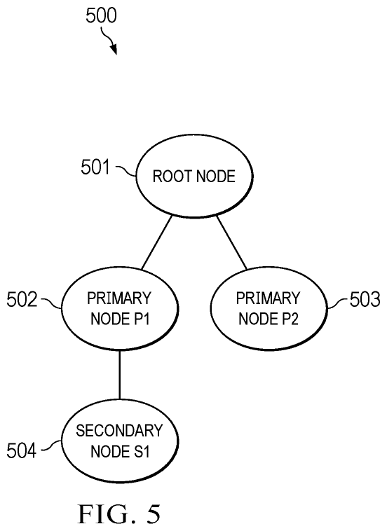

With reference next to FIG. 5, a tree is depicted in accordance with an illustrative embodiment. In this example, tree 500 is an example of hierarchical structure 220 in FIG. 2. In this example, tree 500 is generated in response to processing the log messages in log 410 in FIG. 4. As depicted, root node 501 represents the log containing the log messages. Primary node P1 502 represents the event in log message 401 and log message 402 in log 410 in FIG. 4. Primary node P2 503 represents the event for log message 405 in log 410 in FIG. 4. Secondary node S1 504 represents log message 402 and log message 404 and log 410 in FIG. 4. In this example, secondary node S1 504 contains all of the log message. The primary nodes contain event name but not other information. This event identifier is to identify or correlate primary log messages being reconstructed from log message objects 470 into log messages. Based on this identification, the primary log message can be reconstructed and any secondary log messages can be retrieved from tree 500.

The illustration of tree 500 is presented as an example of one implementation of a hierarchical structure. Further, tree 500 is a simple example of the tree based on a limited number of log messages. With additional log messages, tree 500 can be larger depending on the types of primary log messages and secondary log messages that necessarily follow the primary log messages. For example, a tree may have 11 primary nodes and seven of the primary nodes can have secondary nodes. Of the seven secondary nodes, three of the secondary nodes may have additional secondary nodes that depend from those nodes. Another secondary log message may be present in addition to the secondary live message represented by secondary node S1 504.

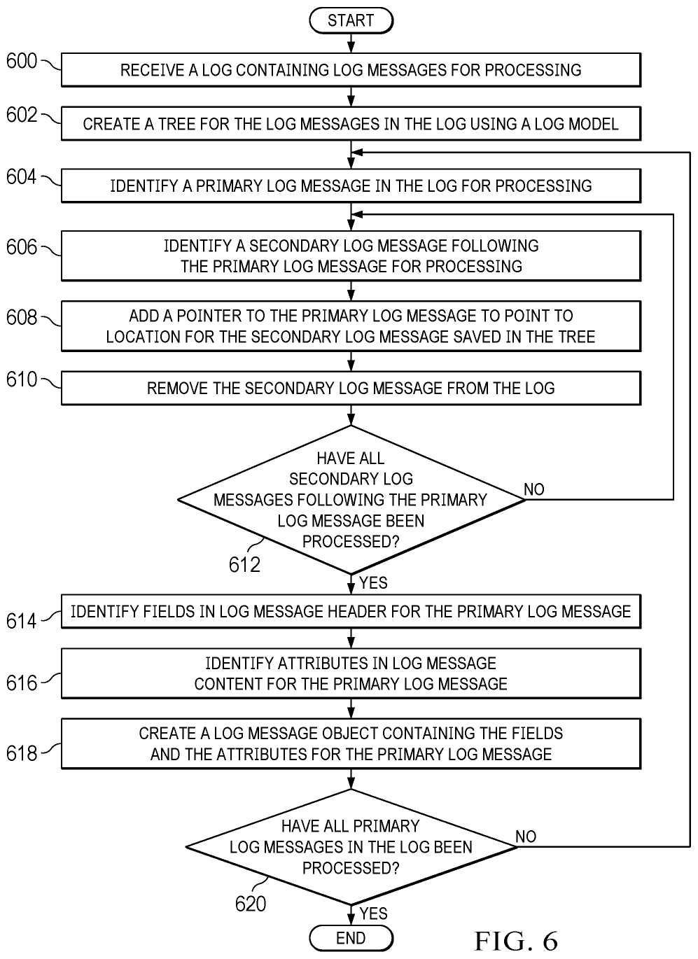

Turning next to FIG. 6, a flowchart of a process for creating log message objects is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in log manager 214 in computer system 212 in FIG. 2.

The process begins by receiving a log containing log messages for processing (step 600). The process creates a tree for the log messages in the log using a log model (step 602). In this illustrative example, the log model is used to create the tree based on primary and secondary relationships between the log messages in the log. As depicted, the log model can be created in a number of different ways. For example, the log model can be an application created according to a set of rules that define relationships between log messages in the log. In this illustrative example, nodes for primary log messages represent events from the primary log messages in the log and nodes for secondary log messages contain all log messages from the secondary log messages in the log.

The process identifies a primary log message in the log for processing (step 604). In this step, the primary log message is an unprocessed primary log message. The process identifies a secondary log message following the primary log message for processing (step 606). As depicted, primary and secondary relationships between log messages are defined by the log model. In this illustrative example, secondary log messages are secondary messages that provide additional information to the primary log message. The primary log message can be followed by multiple secondary log messages in addition to the identified secondary log message. Thus, a primary log message can have one or more other secondary log messages that follow the secondary message in a chain or path in the tree. In step 606, the secondary log message is an unprocessed secondary log message.

The process adds a pointer to the primary log message to point to a location for the secondary message saved in the tree (step 608). As depicted, the pointer can, for example, a special symbol added to the primary log message that indicate the presence of the secondary log message in the tree and location of the secondary log message in the tree.

The process removes the secondary log message from the log (step 610). The process determines whether all secondary log messages following the primary log message have been processed (step 612). If not all secondary log messages following the primary log message have been processed, the process returns to step 606 and repeats step 606 to step 612 until all secondary log messages following the primary log message have been processed.

In this illustrative example, the secondary log message can be identified in a hierarchical manner. In other words, secondary log messages with higher hierarchies are processed before secondary log messages with lower hierarchies. In one example, a primary log message is followed by a first secondary log message, a second secondary log message, and a third secondary log message. The third secondary log message follows the first secondary log message. With this example, the process identifies the first secondary log message and the second secondary log message for processing before proceeding to identifying the third secondary log message for processing.

With reference again to step 612, if all secondary log messages following the primary log message have been processed, the process identifies fields in the log message header for the primary log message (step 614). In step 614, the fields can take a number of different forms. For example, the field can be system name, timestamps, job identifiers, user exit flag, a domain, or other suitable type of field for the primary log message.

The process identifies attributes in log message content for the primary log message (step 616). In step 614, the attributes can also take a number of different forms. For example, the attributes can be event mapping object, parameters mapping object, event identifier, parameter identifiers, secondary log message identifiers, or other suitable type of attribute for the primary log message.

The process creates a log message object containing the fields and the attributes for the primary log message (step 618). The process determines whether all primary log messages in the log have been processed (step 620). If not all primary log messages in the log have been processed, the process returns to step 604 and repeats step 604 to step 620 until all primary log messages in the log have been processed. On the other hand, if all primary log messages in the log have been processed, the process terminates thereafter.

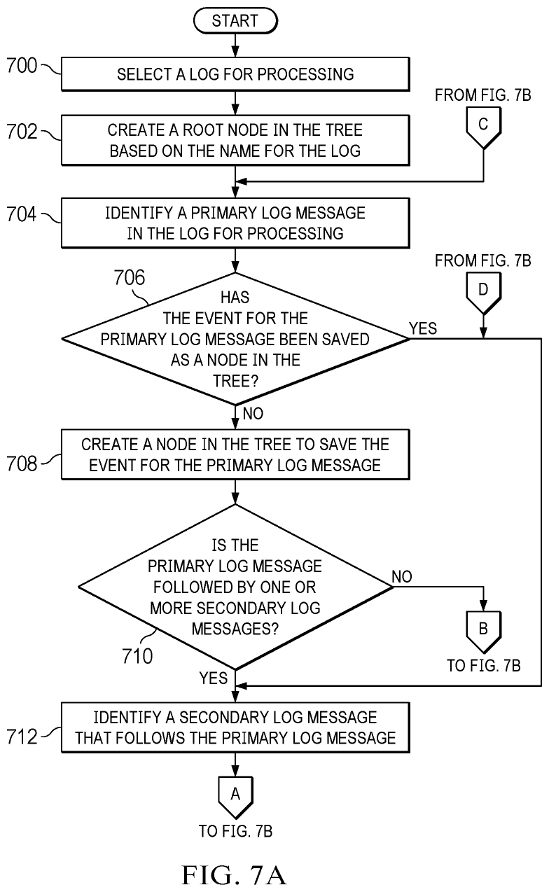

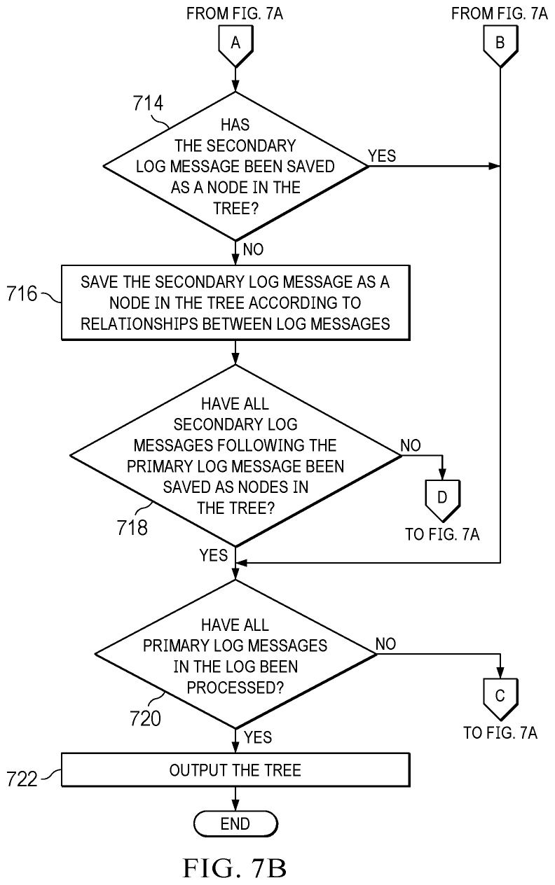

Turning next to FIGS. 7A and 7B, a flowchart of a process for creating a tree for log messages in a log using a log model is depicted in accordance with an illustrative embodiment. The process illustrated in FIGS. 7A and 7B is an example of steps that can be implemented in step 602 in FIG. 6.

The process begins by selecting a log for processing (step 700). The process creates a root node in the tree based on the name for the log (step 702). In this illustrative example, the root node serves as a placeholder that represents the log containing log messages. The process identifies a primary log message in the log for processing (step 704). In step 704, the primary log message is an unprocessed primary log message.

The process determines whether the event for the primary log message has been saved as a node in the tree (step 706). In step 706, log messages include message headers and log message contents. The log message contents include events for activities of computer systems recorded in the log messages. Events can be a wide range of activities. For example, events can be user actions, system operations, error conditions, security-related activities, or any suitable activities for computer systems.

In step 706, multiple primary log messages may be present that have the same event with different parameters. In this example, a node for an event is only generated the first time that that event is encountered in a primary log message.

If the event for the primary log message is not saved as a node in the tree, the process creates a node in the tree to save the event for the primary log message (step 708). In step 708, the node created for the primary log message can be a node at hierarchy immediately below the root node in the tree. The process determines whether the primary log message is followed by one or more secondary log messages (step 710). In step 710, the process can determine whether the primary log message is followed by one or more secondary log messages using the relationships for the log messages.

If the primary log message is followed by one or more secondary log messages, the process identifies a secondary log message that follows the primary log message (step 712).

With reference again to step 706, if the event for the primary log message has been saved as a node in the tree, the process also proceeds to step 712 to identify a secondary log message that follows the primary log message. The process determines whether the secondary log message has been saved as a node in the tree (step 714). If the secondary log message has not been saved as a node in the tree, the process saves the secondary log message as a node in the tree according to relationships between log messages (step 716).

In step 716, the secondary log message is a message below the primary message that can provide additional information to the primary log message and the primary log message can be followed by multiple secondary log messages in addition to the secondary log message. In other words, the node created for the secondary log message is placed in the tree according to the hierarchal relationships between the secondary log message and the primary log message.

For example, if the secondary log message follows the primary log message and does not follow another secondary log message, the node created for the secondary log message is placed at hierarchy immediately below the node for the primary log message. In another example, if the secondary log message follows other secondary log messages that follow the primary log message, the node created for the secondary log message is placed at hierarchy below nodes for the other secondary log messages. In step 716, the entire secondary log message is saved as a node in the tree.

The process determines whether all secondary log messages following the primary log message have been saved as nodes in the tree (step 718). With reference again to step 714, if the secondary log message has been saved as a node in the tree, the process also proceeds to step 718 to determine whether all secondary log messages following the primary log message have been saved as nodes in the tree.

If not all secondary log messages following the primary log message have been saved as nodes in the tree, the process returns to step 712 and repeats step 712 to step 718 until all secondary log messages following the primary log message have been saved as nodes in the tree. On the other hand, if all secondary log messages following the primary log message have been saved as nodes in the tree, the process proceeds to determine whether all primary log messages in the log have been processed (step 720). In this illustrative example, different primary log messages in the log can have the same event. As a result, the tree created using the log model ensures different events from primary log messages in the log are saved as different nodes in the tree to avoid duplication.

With reference again to step 710, if the primary log message is not followed by one or more secondary log messages, the process also proceeds to step 720 to determine whether all primary log messages in the log have been processed.

In step 720, if not all primary log messages in the log have been processed, the process returns to step 706 and repeats step 706 to step 720 until all primary log messages in the log have been processed. On the other hand, if all primary log messages in the log have been processed, the process proceeds to output the tree (step 722). The process terminates thereafter.

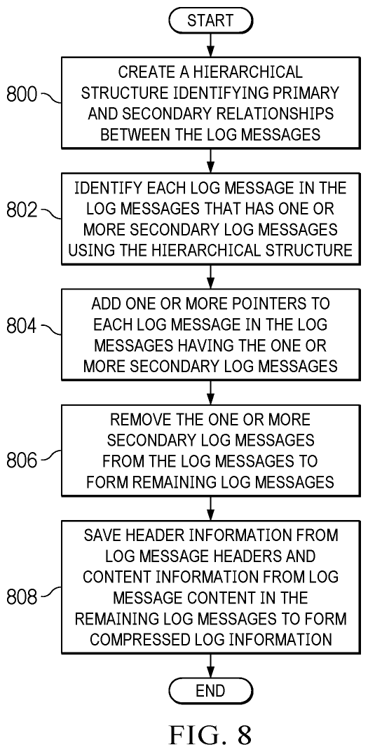

Turning next to FIG. 8, a flowchart of a process for managing log messages is depicted in accordance with an illustrative embodiment. The process in FIG. 8 can be implemented in hardware, software, or both. When implemented in software, the process can take the form of program instructions that are run by one of more computer processors located in one or more hardware devices in one or more computer systems. For example, the process can be implemented in log manager 214 in computer system 212 in FIG. 2.

The process begins by creating a hierarchical structure identifying primary and secondary relationships between the log messages (step 800). The process identifies each log message in the log messages that has one or more secondary log messages using the hierarchical structure (step 802). The process adds one or more pointers to each log message in the log messages having the one or more secondary log messages (step 804). In step 804, each pointer points to a secondary log message in the hierarchical structure.

The process removes the one or more secondary log messages from the log messages to form remaining log messages (step 806). The process saves header information from log message headers and content information from log message content in the remaining log messages to form compressed log information (step 808). The process terminates thereafter.

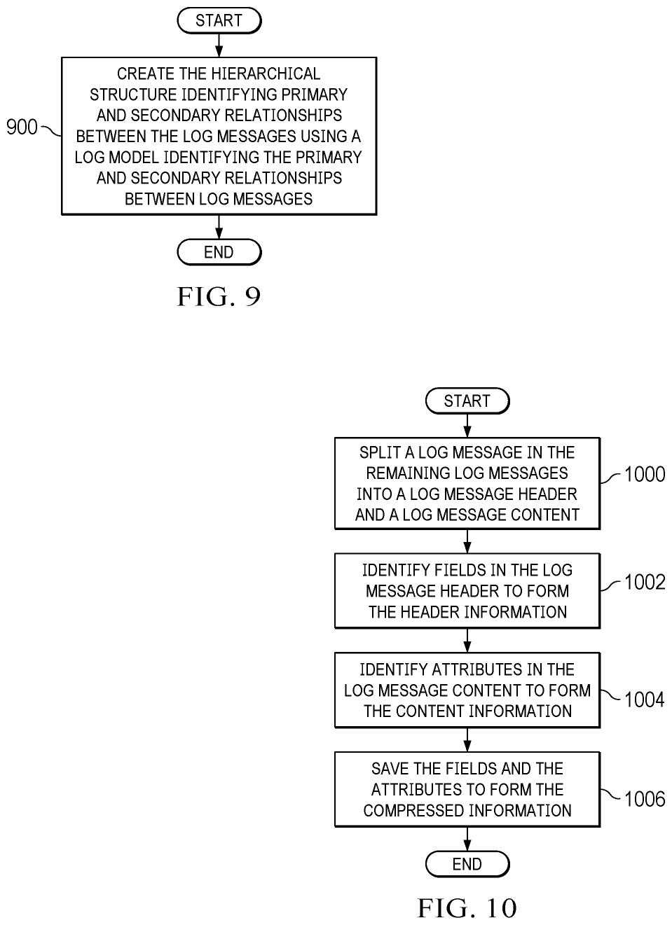

With reference to FIG. 9, an illustration flowchart for creating a hierarchical structure is depicted in accordance with an illustrative embodiment. The process in this figure is an example of an implementation for step 800 in FIG. 8.

The process creates the hierarchical structure identifying primary and secondary relationships between the log messages using a log model identifying the primary and secondary relationships between log messages (step 900). The process terminates thereafter.

Next in FIG. 10, an illustration of a flowchart for saving header information and content information is depicted in accordance with an illustrative embodiment. This flowchart is an example of an implementation for step 808 in FIG. 8.

The process splits a log message in the remaining log messages into a log message header and a log message content (step 1000). The process identifies fields in the log message header to form the header information (step 1002). The process identifies attributes in the log message content to form the content information (step 1004).

The process saves the fields and the attributes to form the compressed information (step 1006). The process terminates thereafter.

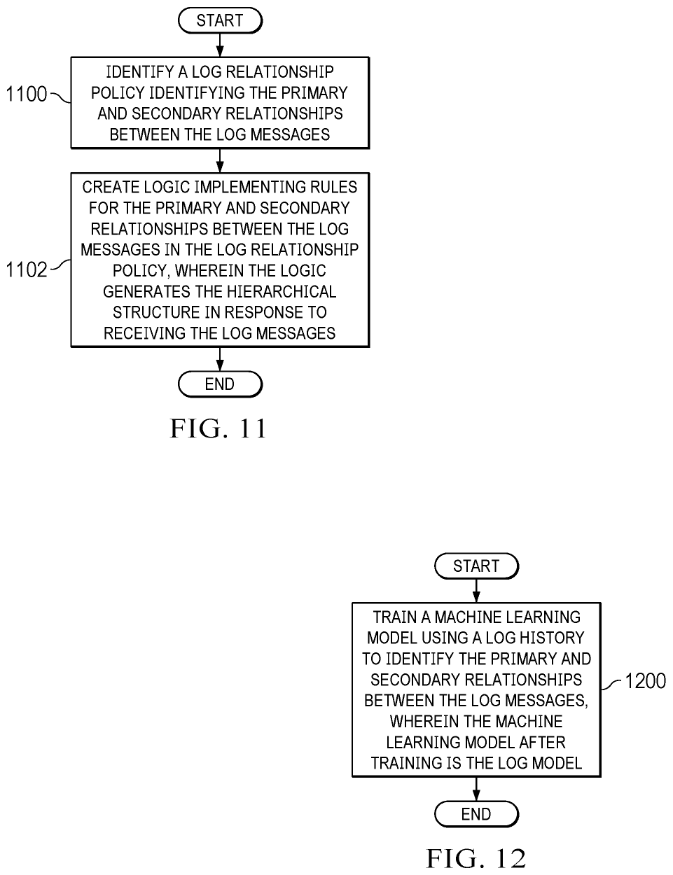

With reference to FIG. 11, a flowchart of a process for creating log model is depicted in accordance with an illustrative embodiment. The process in this figure is an example of additional steps that can be performed with the steps in FIG. 8.

The process identifies a log relationship policy identifying the primary and secondary relationships between the log messages (step 1100). The process creates logic implementing rules for the primary and secondary relationships between the log messages in the log relationship policy, wherein the logic generates the hierarchical structure in response to receiving the log messages (step 1102). The process terminates thereafter.

Turning to FIG. 12, a flowchart of a process for creating a log model is depicted in accordance with an illustrative embodiment. The process in this figure is an example of an additional step that can be performed with the steps in FIG. 8.

The process trains a machine learning model using a log history to identify the primary and secondary relationships between the log messages, wherein the machine learning model after training is the log model (step 1200). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

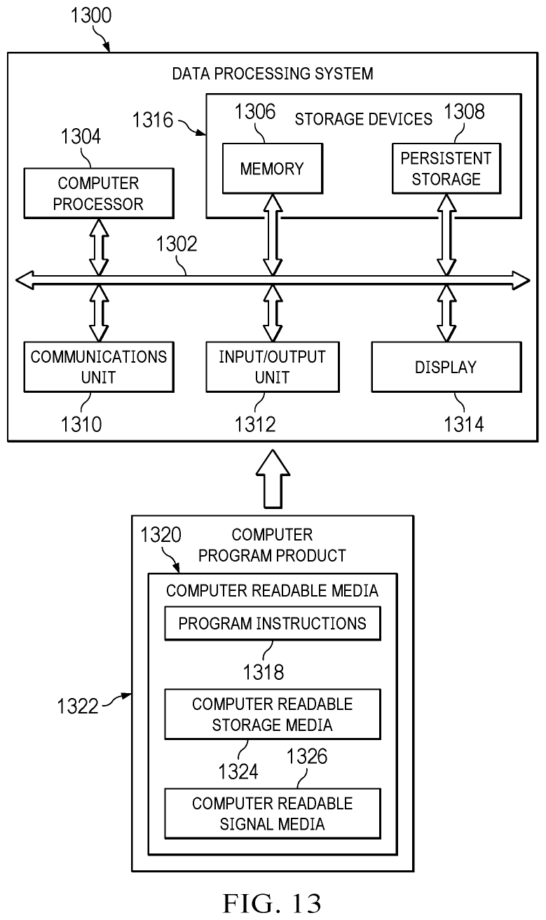

Turning now to FIG. 13, a block diagram of a data processing system is depicted in accordance with an illustrative embodiment. Data processing system 1300 can be used to implement computers and computing devices in computing environment 100 in FIG. 1. Data processing system 1300 can also be used to implement computer system 212 in FIG. 2. In this illustrative example, data processing system 1300 includes communications framework 1302, which provides communications between computer processor 1304, memory 1306, persistent storage 1308, communications unit 1310, input/output (I/O) unit 1312, and display 1314. In this example, communications framework 1302 takes the form of a bus system.

Computer processor 1304 serves to execute instructions for software that can be loaded into memory 1306. Computer processor 1304 includes one or more processors. For example, computer processor 1304 can be selected from at least one of a multicore processor, a central processing unit (CPU), a graphics processing unit (GPU), a physics processing unit (PPU), a digital signal processor (DSP), a network processor, or some other suitable type of processor. Further, computer processor 1304 can be implemented using one or more heterogeneous processor systems in which a main processor is present with secondary processors on a single chip. As another illustrative example, computer processor 1304 can be a symmetric multi-processor system containing multiple processors of the same type on a single chip.

Memory 1306 and persistent storage 1308 are examples of storage devices 1316. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1316 may also be referred to as computer readable storage devices in these illustrative examples. Memory 1306, in these examples, can be, for example, a random-access memory or any other suitable volatile or non-volatile storage device. Persistent storage 1308 may take various forms, depending on the particular implementation.

For example, persistent storage 1308 may contain one or more components or devices. For example, persistent storage 1308 can be a hard drive, a solid-state drive (SSD), a flash memory, a rewritable optical disk, a rewritable magnetic tape, or some combination of the above. The media used by persistent storage 1308 also can be removable. For example, a removable hard drive can be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that can be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs can be located in storage devices 1316, which are in communication with computer processor 1304 through communications framework 1302. The processes of the different embodiments can be performed by computer processor 1304 using computer-implemented instructions, which may be located in a memory, such as memory 1306.

These instructions are referred to as program instructions, computer usable program instructions, or computer readable program instructions that can be read and executed by a processor in computer processor 1304. The program instructions in the different embodiments can be embodied on different physical or computer readable storage media, such as memory 1306 or persistent storage 1308.

Program instructions 1318 are located in a functional form on computer readable media 1320 that is selectively removable and can be loaded onto or transferred to data processing system 1300 for execution by computer processor 1304. Program instructions 1318 and computer readable media 1320 form computer program product 1322 in these illustrative examples. In the illustrative example, computer readable media 1320 is computer readable storage media 1324.

Computer readable storage media 1324 is a physical or tangible storage device used to store program instructions 1318 rather than a medium that propagates or transmits program instructions 1318. Computer readable storage media 1324, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1318 can be transferred to data processing system 1300 using a computer readable signal media 1326. The computer readable signal media 1326 are signals and can be, for example, a propagated data signal containing program instructions 1318. For example, the computer readable signal media 1326 can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1320” can be singular or plural. For example, program instructions 1318 can be located in computer readable media 1320 in the form of a single storage device or system. In another example, program instructions 1318 can be located in computer readable media 1320 that is distributed in multiple data processing systems. In other words, some instructions in program instructions 1318 can be located in one data processing system while other instructions in program instructions 1318 can be located in one data processing system. For example, a portion of program instructions 1318 can be located in computer readable media 1320 in a server computer while another portion of program instructions 1318 can be located in computer readable media 1320 located in a set of client computers.

The different components illustrated for data processing system 1300 are not meant to provide architectural limitations to the manner in which different embodiments can be implemented. In some illustrative examples, one or more of the components may be incorporated in or otherwise form a portion of, another component. For example, memory 1306, or portions thereof, may be incorporated in computer processor 1304 in some illustrative examples. The different illustrative embodiments can be implemented in a data processing system including components in addition to or in place of those illustrated for data processing system 1300. Other components shown in FIG. 13 can be varied from the illustrative examples shown. The different embodiments can be implemented using any hardware device or system capable of running program instructions 1318.

Thus, illustrative embodiments of the present invention provide a computer implemented method, computer system, and computer program product for managing log messages. One or more computer processors create a hierarchical structure identifying primary and secondary relationships between the log messages. The one or more computer processors identify each primary log message in the log messages that has one or more secondary log messages using the hierarchical structure. The one or more computer processors add one or more pointers to each primary log message in the log messages having the one or more secondary log messages, wherein each pointer points to a secondary log message in the hierarchical structure. The one or more computer processors remove the one or more secondary log messages from the log messages to form remaining log messages. The one or more computer processors save header information from log message headers and content information from log message content in the remaining log messages to form compressed log information.

The illustrative examples can reduce issues with logs that use large amounts of storage. In one or more illustrative examples, the log is compressed or simplified. The structure of the log is changed based on a log model that has logic implementing rules on the relationship between log messages. This log model can reduce redundant information in the log file to reduce storage usage. The log messages in the log can be simplified based on the rules in the log model. Further, a tree or other hierarchical structure is created to identify the relationships between log messages in the log.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for managing log messages, the computer implemented method comprising:
creating, by one or more computer processors, a hierarchical structure identifying primary and secondary relationships between the log messages;
identifying, by the one or more computer processors, each primary log message in the log messages that has one or more secondary log messages using the hierarchical structure;
adding, by the one or more computer processors, one or more pointers to each primary log message in the log messages having the one or more secondary log messages, wherein each pointer points to a secondary log message in the hierarchical structure;
removing, by the one or more computer processors, the one or more secondary log messages from the log messages to form remaining log messages; and
saving, by the one or more computer processors, header information from log message headers and content information from log message content in the remaining log messages to form compressed log information.

2. The computer implemented method of claim 1, wherein creating, by the one or more computer processors, the hierarchical structure comprises:
creating, by the one or more computer processors, the hierarchical structure identifying primary and secondary relationships between the log messages using a log model identifying the primary and secondary relationships between log messages.

3. The computer implemented method of claim 1, wherein saving, by the one or more computer processors, the header information from the log message headers and the content information from the log message content comprises:
splitting, by the one or more computer processors, a log message in the remaining log messages into a log message header and a log message content;
identifying, by the one or more computer processors, fields in the log message header to form the header information;
identifying, by the one or more computer processors, attributes in the log message content to form the content information; and
saving, by the one or more computer processors, the fields and the attributes to form the compressed log information.

4. The computer implemented method of claim 3, wherein the fields are selected from at least one of a system name, a timestamp, a job identifier, a user exit flag, or a domain.

5. The computer implemented method of claim 3, wherein the attributes are selected from at least one of an event mapping object, a parameters mapping object, an event identifier, a parameter identifier, or a secondary log message identifier.

6. The computer implemented method of claim 1 further comprising:
identifying, by the one or more computer processors, a log relationship policy identifying the primary and secondary relationships between the log messages; and
creating, by the one or more computer processors, logic implementing rules for the primary and secondary relationships between the log messages in the log relationship policy, wherein the logic generates the hierarchical structure in response to receiving the log messages.

7. The computer implemented method of claim 1 further comprising:
training, by the one or more computer processors, a machine learning model using a log history to identify the primary and secondary relationships between the log messages, wherein the machine learning model after training is the log model.

8. The computer implemented method of claim 1, wherein the hierarchical structure is selected from a group comprising a tree structure, a directed acyclic graph, a database, and a multilevel list.

9. A computer system for managing log messages comprising:
one or more computer processors;
one or more computer readable storage devices; and
computer program instructions, the computer program instructions being stored on the one or more computer readable storage devices for execution by the one or more of computer processors to perform one or more operations to:
create a hierarchical structure identifying primary and secondary relationships between log messages;
identify each primary log message in the log messages that has one or more secondary log messages using the hierarchical structure;
add one or more pointers to each primary log message in the log messages having the one or more secondary log messages, wherein each pointer points to a secondary log message in the hierarchical structure;
remove one or more secondary log messages from the log messages to form remaining log messages; and
save header information from log message headers and content information from log message content in the remaining log messages to form compressed log information.

10. The computer system of claim 9, wherein as part of creating the hierarchical structure, the computer program instructions are further executable by the one or more of computer processors to perform one or more operations to:
create the hierarchical structure identifying primary and secondary relationships between the log messages using a log model identifying the primary and secondary relationships between log messages.

11. The computer system of claim 9, wherein as part of saving the header information from the log message headers and the content information from the log message content, the computer program instructions are further executable by the one or more of computer processors to perform one or more operations to:
split a log message in the remaining log messages into a log message header and a log message content;
identify fields in the log message header to form the header information;
identify attributes in the log message content to form the content information; and
save the fields and the attributes to form the compressed log information.

12. The computer system of claim 11, wherein the fields are selected from at least one of a system name, a timestamp, a job identifier, a user exit flag, or a domain.

13. The computer system of claim 11, wherein the attributes are selected from at least one of an event mapping object, a parameters mapping object, an event identifier, a parameter identifier, or a secondary log message identifier.

14. The computer system of claim 9, wherein the computer program instructions are further executable by the one or more of computer processors to perform one or more operations to:
identify a log relationship policy identifying the primary and secondary relationships between the log messages; and
create logic implementing rules for the primary and secondary relationships between the log messages in the log relationship policy, wherein the logic generates the hierarchical structure in response to receiving the log messages.

15. The computer system of claim 9, wherein the computer program instructions are further executable by the one or more of computer processors to perform one or more operations to:
train, by the one or more computer processors, a machine learning model using a log history to identify the primary and secondary relationships between the log messages, wherein the machine learning model after training is the log model.

16. The computer system of claim 9, wherein the hierarchical structure is selected from a group comprising a tree structure, a directed acyclic graph, a database, and a multilevel list.

17. A computer program product for managing log messages, the computer program product comprising a computer readable storage device having computer program instructions embodied therewith, the computer program instructions executable by a computer system to cause the computer system to:
create a hierarchical structure identifying primary and secondary relationships between the log messages;
identify each primary log message in the log messages that has one or more secondary log messages using the hierarchical structure;
add one or more pointers to each primary log message in the log messages having the one or more secondary log messages, wherein each pointer points to a secondary log message in the hierarchical structure;
remove one or more secondary log messages from the log messages to form remaining log messages; and
save header information from log message headers and content information from log message content in the remaining log messages to form compressed log information.

18. The computer program product of claim 17, wherein as part of creating the hierarchical structure, the computer program instructions are further executable by the one or more of computer processors to perform one or more operations to:
create the hierarchical structure identifying primary and secondary relationships between the log messages using a log model identifying the primary and secondary relationships between log messages.

19. The computer program product of claim 17, wherein as part of saving the header information from the log message headers and the content information from the log message content, the computer program instructions are further executable by the one or more of computer processors to perform one or more operations to:
split a log message in the remaining log messages into a log message header and a log message content;
identify fields in the log message header to form the header information;
identify attributes in the log message content to form the content information; and
save the fields and the attributes to form the compressed log information.

20. The computer program product of claim 17, wherein the computer program instructions are further executable by the one or more of computer processors to perform one or more operations to:
identify a log relationship policy identifying the primary and secondary relationships between the log messages; and
create logic implementing rules for the primary and secondary relationships between the log messages in the log relationship policy, wherein the logic generates the hierarchical structure in response to receiving the log messages.
